(19) United States
(12) Patent Application Publication
(10) Pub. No.: US 2016/0252777 A1
(43) Pub. Date: Sep. 1, 2016

(54) SURFACE ILLUMINANT DEVICE AND A METHOD FOR MANUFACTURING A SURFACE ILLUMINANT DEVICE

(71) Applicant: 3M INNOVATIVE PROPERTIES COMPANY, Saint Paul, MN (US)

(72) Inventor: Kazuhiko TOYOOKA, Yamagata Prefecture (JP)

(21) Appl. No.: 15/032,896

(22) PCT Filed: Oct. 28, 2014
(86) PCT No.: PCT/US2014/062641

§ 371 Date: Apr. 28, 2016

(30) Foreign Application Priority Data
Oct. 29, 2013 (JP) 2013-224323

(51) Int. Cl. G02F 1/1335; F21V 8/00

(52) U.S. Cl. CPC G02F 1/133606; G02F 1/133603; G02F 1/133608; G02B 6/0051; G02B 6/0055

(57) ABSTRACT

In a surface illuminant device provided with a light source for emitting light, a nonwoven fabric configured as a diffusion member for diffusing the light, and an optical sheet disposed on at least one of the back side and the front side of the nonwoven fabric, both the nonwoven fabric and the optical sheet are at least fixed with a fixing part in the area of one edge side of the nonwoven fabric in a first direction along the surface direction, and for one fixing part, a part of the area is fixed in a direction along at least one edge.

### FIELD

The present invention relates to a surface illuminant device and a method for manufacturing a surface illuminant device.

### BACKGROUND

Various configurations have been proposed as surface illuminant devices for emitting light. For example, according to Unexamined Patent Application Publication JP 2013-25953 (Patent Document 1), it is well known that a surface illuminant device is provided with a light source for emitting light, a nonwoven fabric configured as a diffusion member for diffusing light, and an optical sheet disposed on at least one of the back side and the front side of the nonwoven fabric.

### SUMMARY

In the surface illuminant device described above, a nonwoven fabric is used as the diffusion member for diffusing light. Because the member itself is weak compared to normal diffuser plates, some kind of support mechanism is needed for said nonwoven fabric. However, there are times it is not appropriate to use a large-scale mechanism just to support the nonwoven fabric. At the same time, when supporting the nonwoven fabric with a simple configuration, there could be optical disadvantages, such as wrinkles forming in the nonwoven fabric. Therefore, there is a need for a surface illuminant device capable of ensuring sufficient optical properties with a simple configuration, even when using a nonwoven fabric as a diffusion member.

In a surface illuminant device according to one configuration of the present invention provided with a light source for emitting light, a nonwoven fabric configured as a diffusion member for diffusing the light, and an optical sheet disposed on at least one of the back side and the front side of the nonwoven fabric, both the nonwoven fabric and the optical sheet are at least fixed with a fixing part in the area of one edge side of said nonwoven fabric in a first direction along the surface direction, and for one fixing part, a part of the area is fixed in a direction along at least one edge.

According to this configuration, by fixing both the nonwoven fabric and optical sheet with a fixing part, they can be treated as one joined sheet in which said nonwoven fabric and said optical sheet are combined with each other. Therefore, even when using a low-strength nonwoven fabric as a diffusion member, because it is possible to configure it as one joined sheet, the strength of the member can be ensured, even with a simple configuration. In addition, both the nonwoven fabric and the optical sheet are at least fixed with a fixing part in the area of one edge side of the nonwoven fabric in a first direction along the surface direction. In addition, for one fixing part, a part of an area is fixed in a direction along at least one edge. Because both the nonwoven fabric and optical sheet are fixed with this fixing part, even when it is affected by heat or the like, the generation of wrinkles or the like in the nonwoven fabric can be suppressed. Accordingly, sufficient optical properties can be ensured with a simple configuration, even when using a nonwoven fabric as a diffusion member.

In a surface illuminant device according to a different configuration, the nonwoven fabric has a rectangular shape, and the fixing part may be formed in the corner between one edge and an edge adjacent to said edge.

In a surface illuminant device according to a different configuration, the surface illuminant device may be further provided with a support member for supporting the nonwoven fabric and optical sheet; the nonwoven fabric and optical sheet may be provided with a positioning part for adjusting their mutual positions in the surface direction; the positioning part may be configured to be connectable to the support member; and the fixing part may be formed at a position corresponding to the positioning part.

In a surface illuminant device according to a different configuration, for the fixing part, both the nonwoven fabric and optical sheet may be fixed without a gap formed between the nonwoven fabric and optical sheet.

In a method for manufacturing a surface illuminant device according to a configuration of the present invention provided with a light source for emitting light, a nonwoven fabric configured as a diffusion member for diffusing the light, and an optical sheet disposed on the back side or the front side of the nonwoven fabric, both the nonwoven fabric and the optical sheet are at least fixed with a fixing part in the area of one edge side of the nonwoven fabric in a first direction along the surface direction, and for one fixing part, a part of the area is fixed in a direction along at least one edge.

According to the present invention, sufficient optical properties can be ensured with a simple configuration, even when using a nonwoven fabric as a diffusion member.

### BRIEF DESCRIPTION OF THE DRAWINGS

FIG. 1 is a schematic view showing a configuration of the surface illuminant device according to one embodiment of the present invention.

FIG. 2 is a schematic view showing a configuration of the surface illuminant device according to a different embodiment of the present invention.

FIG. 3 is a view showing the appearance of transmission and diffusion of light in nonwoven fabric.

FIG. 4 is a schematic view showing a partial configuration of the surface illuminant device according to one embodiment of the present invention.

FIG. 5 is an enlarged view showing the configuration in the vicinity of the fixing part.

FIG. 6 is a conceptual view for describing the size of the fixing part and the like.

FIG. 7 is a conceptual view for describing the arrangement of the fixing part and the like.

FIG. 8 is a view for describing one example of the shape of the fixing part.

FIG. 9 is an enlarged sectional view of the joined sheet in the vicinity of the fixing part.

FIG. 10 is a conceptual view showing variations in the positioning part.

FIG. 11 is a conceptual view showing variations in the positioning part.

### DETAILED DESCRIPTION

Various embodiments of the surface illuminant device according to the present invention will be described in detail below with reference to the drawings. In the description of the drawings, the same numerals are used for the same elements, and redundant descriptions are omitted.

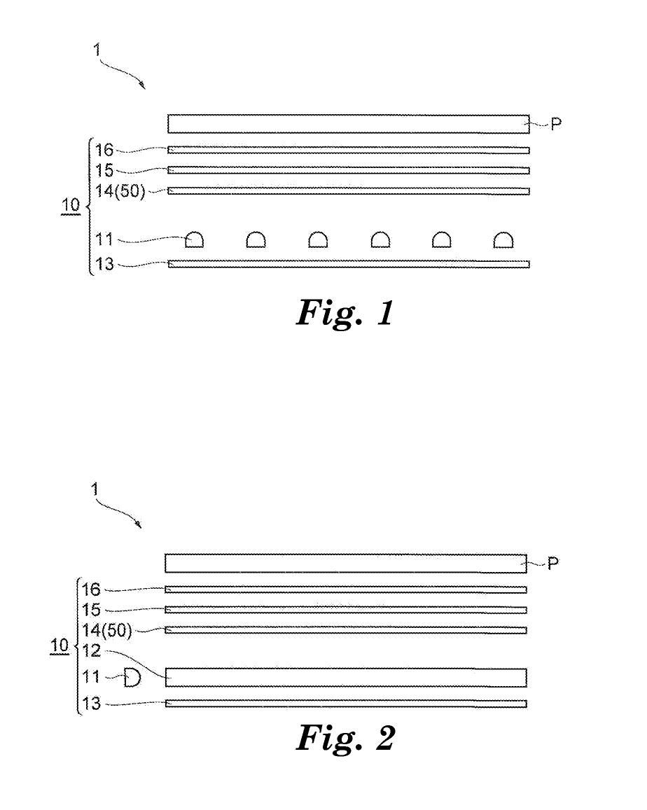

FIG. 1 is a schematic view showing a configuration of the surface illuminant device according to one embodiment of the present invention. As shown in the figure, surface illuminant device 10 is provided with a light source 11, a reflector plate 13, a diffusion member 14, a prism sheet (optical sheet) 15, and a reflective polarizing plate (optical sheet) 16. Surface illuminant device 10 is combined with a liquid crystal panel P, for example, and that forms a liquid crystal display module 1 used in monitors for televisions and personal computers.

The liquid crystal panel P is used by affixing a linear polarizing plate to the surface of a known liquid crystal cell, such as a TFT, STN, IPS, VA, or the like. The liquid crystal cell is configured by including, for example, a plurality of substrates, electrodes installed on each substrate, a liquid crystal layer enclosed between substrates, an oriented film, a spacer, a color filter, and the like. The light source 11 shown here is an example of an LED (light-emitting diode). A plurality of light sources 11 are arrayed at a fixed spacing along the surface direction. Furthermore, a CCFL (cold cathode fluorescent lamp) or the like can also be used as the light source 11.

For the reflector plate 13, a plate-like member made of resin with a metal thin film, such as silver or aluminum, deposited on its surface or a reflective film of a dielectric with an ultra-multilayer structure or the like can be used. Reflector plate 13 is disposed on the back side of light source 11. The luminance of the light emitted from surface illuminant device 10 is ensured by the reflection of the light leaked from the back side of light source 11 to the side with diffusion member 14. Reflector plate 13 may also be a resin plate colored with white on the surface or a metal plate consisting of aluminum or the like.

Diffusion member 14 is a plate-like member formed from a nonwoven fabric, for example. Diffusion member 14 is disposed on the front side of light source 11. The uniformity of the light emitted from surface illuminant device 10 is ensured by the diffusion of the light incident upon the front side from light source 11.

Examples of resins that can be used to constitute the nonwoven fabric include general-purpose plastics, such as polyethylene, polypropylene, and polyethylene terephthalate, and engineering plastics, such as polybutyrene terephthalate and polyphenylene sulfide. The grammage of the nonwoven fabric is 10 g/m² or more and 500 g/m² or less, preferably 10 g/m² or more and 250 g/m² or less. In addition, for the basic properties that are needed for the aforementioned resin, low optical absorption and high transmittance are preferred. For a monolayer sample with a thickness of 50 microns, a material with a total light transmittance of 70% or more or even 80% or more may be used. For a monolayer sample with a thickness of 100 microns, a material with a total light transmittance of 40% or more or even 50% or more may be used. In this case, a monolayer sample with a thickness of 50 microns or 100 microns is produced from the resin to be used, and the total light transmittance can be measured by a method conforming to JISK 7361-1 (1997).

Prism sheet 15 is a sheet-like member formed from a material with certain translucency, for example. A plurality of prisms are arrayed on the front or back of prism sheet 15 in order to align and transform the direction of the emission of the light passing through diffusion member 14. Specifically, prism sheet 15 is configured by including both a first polymer layer comprising, for example, a microstructure surface and a second polymer layer disposed on the side opposite the microstructure surface. The microstructure surface includes an array of prisms for orienting the light. Through the refraction and total reflection of prism sheet 15, some of the light is oriented to the front, and the rest of the light is returned to the nonwoven fabric side (the side with light source 11). In this way, the light that is returned strikes the nonwoven fabric and is again scattered and diffused with little loss. After the transmission or reflection by each member, it is again emitted in the direction of the prism from the nonwoven fabric, and as a result, the luminance in the frontal direction to the screen can be effectively increased.

Reflective polarizing plate 16 is a plate-like member that is constituted by including at least 2 polymer layers. Reflective polarizing plate 16 is disposed on the front side of prism sheet 15. It reflects light in a first polarization state based on the difference between the refractive indexes of the polymer layers, and it transmits light in a second polarization state approximately orthogonal to the first polarization state.

At least 1 of the polymer layers can include naphthalate functionality. This naphthalate functionality is incorporated into the polymer layer by polymerizing one or more monomers including naphthalate functionality. Examples of monomers include naphthalates such as 2,6-, 1,4-, 1,5-, 2,7-, and 2,3-naphthalenedicarboxylic acid and esters thereof.

In addition, at least 1 of the polymer layers can include polyethylene naphthalate (PEN), which is a copolymer of 2,6-, 1,4-, 1,5-, 2,7-, and/or 2,3-naphthalenedicarboxylic acid and ethylene glycol, for example.

FIG. 2 is a schematic view showing a configuration of the surface illuminant device according to a different embodiment of the present invention. The surface illuminant device 10 that constitutes liquid crystal display module 1 shown in the figure is different from the embodiment shown in FIG. 1 in that it has light guide plate 12. In addition, reflector plate 13 is disposed on the back side of light guide plate 12. Otherwise, it is the same as the embodiment shown in FIG. 1. A plurality of light sources 11 are arrayed at a fixed spacing along the side of the surface with light guide plate 12. Furthermore, an LED (light-emitting diode), a CCFL (cold cathode fluorescent lamp) or the like can be used as the light source 11. In addition, in some cases, light source 11 is disposed along the back side of light guide plate 12, 2 sides facing light guide plate 12, or all sides of light guide plate 12. Light guide plate 12 is a plate-like member several millimeters thick formed from a material with translucency, such as an acrylic resin. The refractive index of light guide plate 12 is set around 1.5, for example. Light guide plate 12 guides the light emitted from light source 11 into the side surface and emits it from the front side. Furthermore, various additives can be added to light guide plate 12 as necessary, such as light-diffusing agents, ultraviolet absorption agents, thermal stabilizers, and polymerization stabilizers.

In a surface illuminant device 10 with the above configuration, diffusion member 14 disposed on the front side of light guide plate 12 or the front side of light source 11 can be formed from a nonwoven fabric 50 at 10 g/m² or more and 500 g/m² or less, preferably 10 g/m² or more and 250 g/m² or less. In diffusion members retaining a light-diffusing agent as a binder, such as acrylic beads, as in conventional diffusion members, because there is a small difference between the refractive index of the binder and the beads, which are the diffusing element, the optical boundary needs to be increased in order to obtain sufficient diffusivity, but these boundary sections also cause optical losses.

By contrast, in a diffusion member 14 making use of nonwoven fabric 50 as described above, the difference in the refractive index between the resin that constitutes nonwoven fabric 50 and the surrounding air can be sufficiently ensured, so when the light is diffused by the boundary of nonwoven fabric 50, the optical losses can be suppressed. In this way, when the grammage of nonwoven fabric 50 is decreased, the diffusivity of diffusion member 14 tends to decrease, and the transparency tends to increase. In addition, when the grammage of nonwoven fabric 50 is increased, the diffusivity of diffusion member 14 tends to increase, and the transparency tends to decrease. However, if the grammage of nonwoven fabric 50 is increased above a certain point, the diffusivity of diffusion member 14 becomes saturated.

Because of this, by setting the grammage of nonwoven fabric 50 to 10 g/m² or more and 500 g/m² or less as in the above embodiment, both the transparency and diffusivity of diffusion member 14 can be maintained at a high level. As a result, uniformity and high luminance can be achieved from the light emitted from surface illuminant device 10. By making the light emitted from surface illuminant device 10 uniform, the elimination of irregularities (hot spots) in the light in the display part of liquid crystal panel P due to the parts where a light source 11 is and is not disposed can be realized.

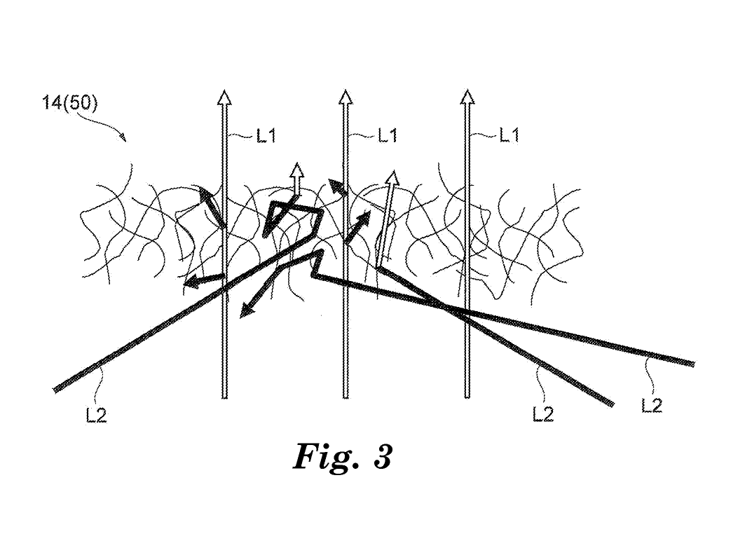

In addition, in a diffusion member 14 using nonwoven fabric 50 as shown in FIG. 3, a part of the light L1 entering approximately orthogonally to the diffusion member 14 is diffused, but when the losses are suppressed, it is transmitted to the front side of diffusion member 14. Accordingly, for certain embodiments, a resin with low light absorption and high transmittance is preferred for the resin used for nonwoven fabric 50. On the other hand, light L2 incident upon diffusion member 14 at an angle is roughly diffused by nonwoven fabric 50, but a part of the light is transmitted to the front side of diffusion member 14 like light L1. Therefore, it is possible to increase the intensity of the light emitted in the approximately perpendicular direction from diffusion member 14 on the front side of diffusion member 14 higher than the intensity of the light incident upon the approximately perpendicular direction from the back side of diffusion member 14.

This luminance improvement effect can be further increased by disposing diffusion member 14 and reflector plate 13 on opposing sides as shown in FIG. 1 and FIG. 2. Namely, by disposing diffusion member 14 and reflector plate 13 on opposite sides, the light reflected to the back side of diffusion member 14 at the boundary of nonwoven fabric 50 is reflected by reflector plate 13 to again be incident upon diffusion member 14, so the light that is transmitted to the front side of diffusion member 14 in the same direction as light L1 can be increased.

In this configuration in which diffusion member 14 and reflector plate 13 are disposed on opposite sides, a further reflective polarizing plate can be provided on the front side of diffusion member 14. A reflective polarizing plate in general is a polarizing plate that can selectively transmit light with a vibration direction parallel to one in-plane axis (transmission axis), and the remaining light is reflected the other way. Namely, it exerts a polarizing effect by transmitting only the portion of the light incident upon the reflective polarizing plate with a vibration direction parallel to said transmission axis.

The light that is not transmitted through this reflective polarizing plate is essentially not absorbed into the reflective polarizing plate; it is reflected. Therefore, the light that is reflected at the reflective polarizing plate is returned to diffusion member 14 and is repeatedly diffused and scattered by diffusion member 14, so the polarized light is partially resolved. The light, which is polarized light that is partially resolved, is again returned toward the reflective polarizing plate, and only a part of the light is transmitted as described above, and a different part is reflected. In this way, the light is recycled between reflector plate 13 and the reflective polarizing plate, and the intensity of the light emitted in the approximately perpendicular direction can be further increased by the repeated behavior of said light at diffusion member 14.

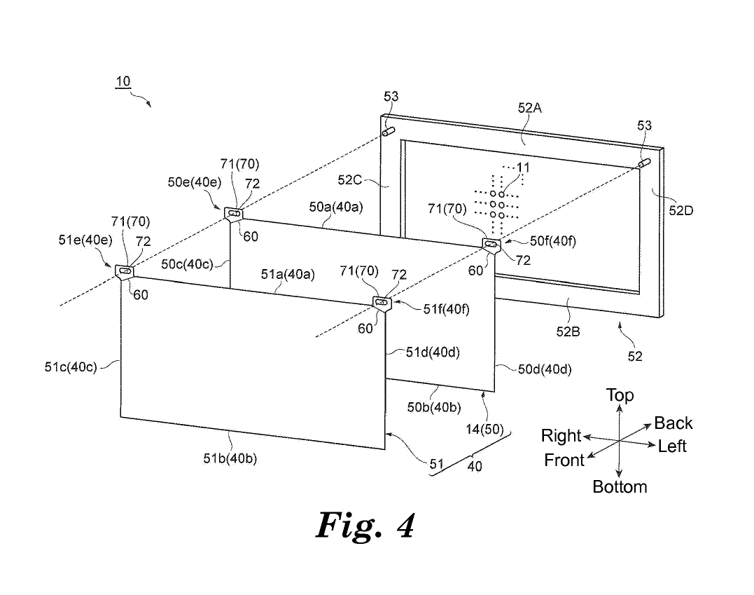

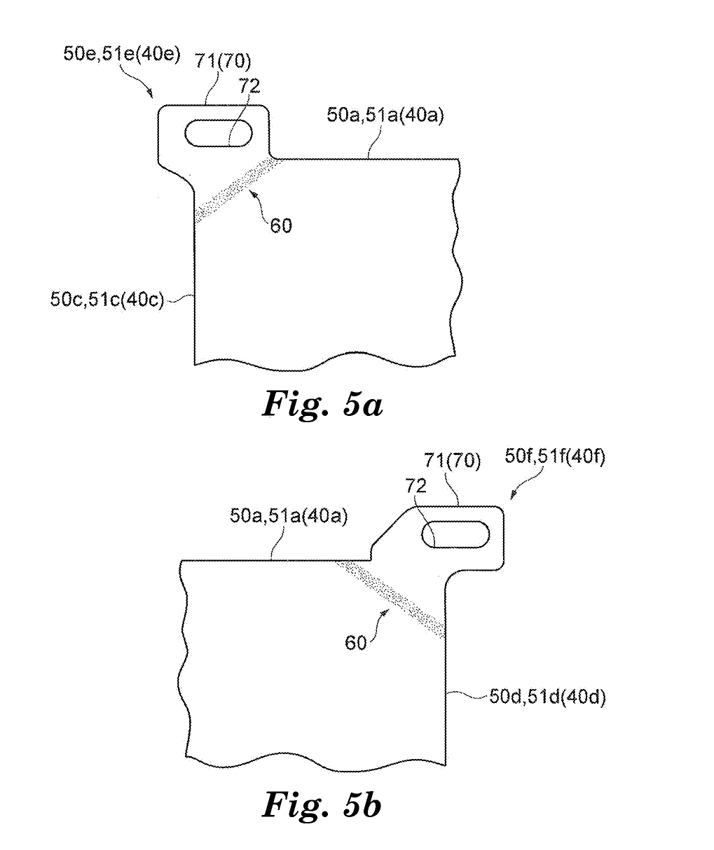

Next, the characteristic parts of surface illuminant device 10 according to the present embodiment will be described in detail with reference to FIG. 4 and FIG. 5.

As shown in FIG. 4 and FIG. 5, surface illuminant device 10 is provided with light source 11 for emitting light as described above, nonwoven fabric 50 configured as diffusion member 14 for diffusing light as described above, optical sheet 51 disposed on the back side or the front side of the nonwoven fabric 50, and support member 52 for supporting nonwoven fabric 50 and optical sheet 51. Furthermore, optical sheet 51 is a sheet-like member that has an optical effect on the light from light source 11, and in the example shown in FIG. 1 and FIG. 2, prism sheet 15 and reflective polarizing plate 16 correspond to optical sheet 51. However, the items that correspond to optical sheet 51 are not limited to these and may be a diffusion film, a microlens film, a transparent film, or the like. Nonwoven fabric 50 and optical sheet 51 may be configured in a rectangular shape with one side with a length of 300 mm or more. In particular, when the configuration of surface illuminant device 10 according to the present embodiment is applied to nonwoven fabric 50 and optical sheet 51 with an up-down size of 350 mm or more and a crosswise size of 600 mm or more for use in large-scale liquid crystal displays, a particularly remarkable effect is achieved. Furthermore, in the above description, the words “left” and “right” would also be appropriate based on the configuration when viewing surface illuminant device 10 from the front.

In addition, both nonwoven fabric 50 and optical sheet 51 are fixed with 1 or a plurality of fixing parts 60 in the area of the upper edge 50a side of nonwoven fabric 50 in the up-down direction (a first direction along the surface direction). By fixing both nonwoven fabric 50 and optical sheet 51 to each other at fixing part 60 by overlapping them, they can be treated as a single sheet-like joined sheet forming one unit. For description purposes, the fixation at fixing part 60 has been undone in FIG. 5, and nonwoven fabric 50 and optical sheet 51 are shown separated from each other. Furthermore, an example will be described in which one optical sheet 51 and nonwoven fabric 50 are disposed on the front side of nonwoven fabric 50 as an example showing the present embodiment. However, fixed optical sheet 51 may be disposed in at lease one of the front side and back side of nonwoven fabric 50, and the number of layers is not particularly limited, and 2 or more layers of nonwoven fabric 50 may be overlapped and fixed.

Support member 52 is a member that is connectable to nonwoven fabric 50 and optical sheet 51, and it is also capable of supporting said nonwoven fabric 50 and optical sheet 51. In the present embodiment, support member 52 is configured from a rectangular-shaped frame member having the 4 edges 50a, 50b, 50c, and 50d capable of supporting the 4 edges 40a, 40b, 40c, and 40d, respectively, of joined sheet 50 (corresponding to the 4 edges 50a, 50b, 50c, and 50d of nonwoven fabric 50 and the 4 edges 50a, 50b, 50c, and 50d of optical sheet 51). Support member 52 is configured from a material at a thickness capable of ensuring a level of strength such that it does not deform under weight, even when supporting joined sheet 50. Support member 52 can provide support by abutting (directly or indirectly) the front surface of each edge 52A, 52B, 52C, and 52D against the back surface of edges 40a, 40b, 40c, and 40d of joined sheet 40. In addition, support member 52 is provided with connection portion 53 for connecting to joined sheet 40. The configuration of said connection portion 53 will be described below.

Nonwoven fabric 50 and optical sheet 51 are provided with positioning part 70 for adjusting their mutual positions in the surface direction. Positioning part 70 is configured by forming a mark such as a protrusion or notch at mutually corresponding positions along the edges of nonwoven fabric 50 and optical sheet 51 or in the corners. In the present embodiment, positioning part 70 is configured by a tab 71 that projects outward at corners 50e and 50f between upper edge 50a of nonwoven fabric 50 and side edges 50c and 50d adjacent to said upper edge 50a. Tab 71 is configured in a roughly rectangular shape projecting diagonally upward from corners 50e, 50f. Tabs 71 with roughly the same shape as the ones formed on nonwoven fabric 50 are also formed on corners 51e, 50f of optical sheet 51 as positioning part 70. When forming joined sheet 40, nonwoven fabric 50 and optical sheet 51 can be aligned in the surface direction by bring together tabs 71 of nonwoven fabric 50 and tabs 71 of optical sheet 51. In addition, positioning part 70 is configured to be connectable to support member 52. Positioning part 70 is connectable to support member 52 by connecting connection portion 53 of support member 52 to the target connection portion 72. In the present embodiment, the target connection portion 72 is configured by a penetrating hole formed in tabs 71. In addition, connection portion 53 is configured via a projection that projects from the front surface of the corner of support member 52. Positioning part 70 is connectable to support member 52 by the insertion of the projection of connection portion 53 through the penetrating hole of target connection portion 72. In the present embodiment, target connection portion 72 is configured from an elongated penetrating hole, but the shape of the penetrating hole is not particularly limited to a circular or rectangular shape or the like, and it may be a notch or the like and not a penetrating hole. In addition, the shape of connection portion 53 is not particularly limited and may be not simply a projection but also a hook or the like. Furthermore, in FIG. 4, the tabs 71 of positioning part 70 are deformed and shown enlarged for the purpose of describing them, but the actual tabs 71 are configured to be extremely small compared to the size of the whole nonwoven fabric 50 itself.

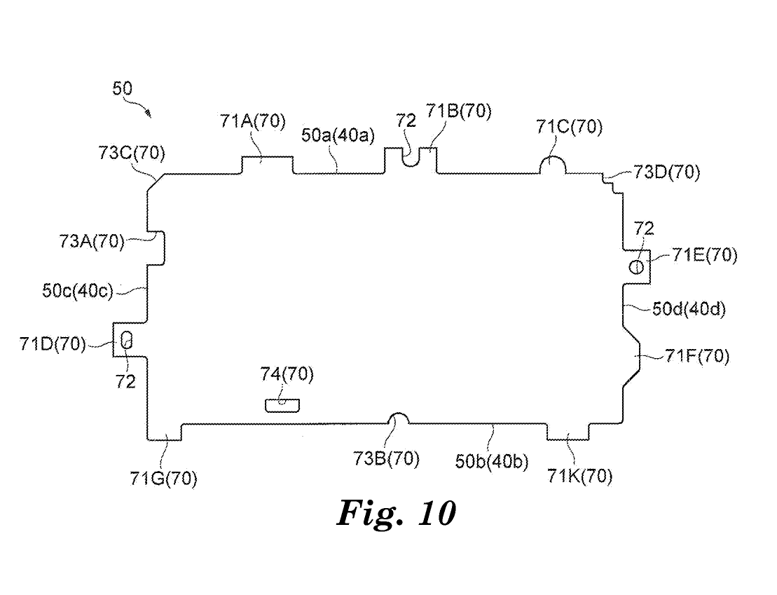

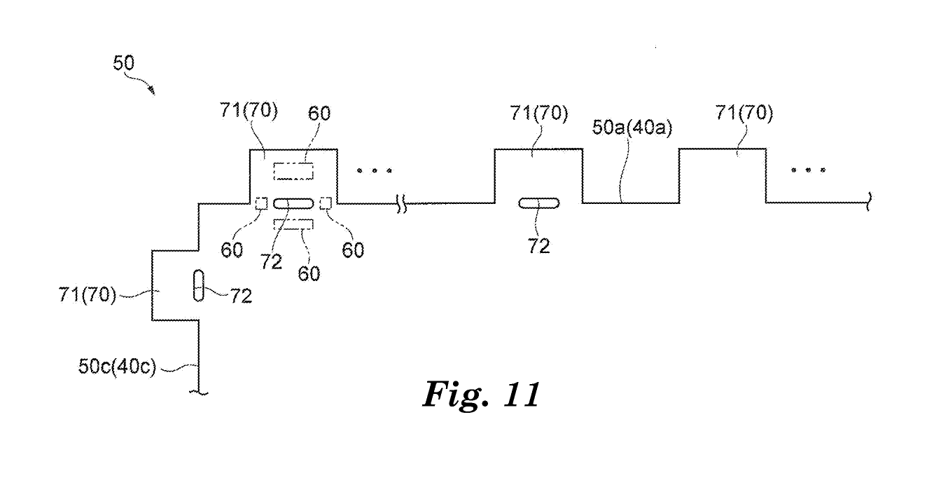

Furthermore, positioning part 70 via tabs 71 shown in FIG. 4 and FIG. 5 are nothing more than an example, and the shape and position of positioning part 70 and the configuration of target connection portion 73 can also be changed as appropriate. For example, as shown in FIG. 11, rectangular-shaped tabs 71 may be formed to project from upper edge 50a in the vicinity of the corner of nonwoven fabric 50, and rectangular-shaped tabs 71 may be formed to project from side edge 50c. In addition, a plurality of tabs 71 may be formed along each edge, and the length of each tab 71 may also be changed as appropriate. In addition, while a portion of tabs 71 may form target connection portion 72, the other portion of tabs 71 may optionally not form target connection portion 72. In addition, as shown in FIG. 10, any structure can be used for positioning part 70. Furthermore, FIG. 10 shows various variations of positioning part 70 in 1 sheet of nonwoven fabric 50, and each part may be used for positioning part 70. For example, the shape is not limited to the tab 71 projecting diagonally outward from the corner as described above. It may optionally not be formed at the corner and may use tab 71A, 71B, or 71C projecting outward from any position on upper edge 50a. In addition, besides 50a, tab 71D formed on side edge 50c may be used, tabs 71E and 71F formed on side edge 50d may be used, and tabs 71G and 71K formed on lower edge 50b may be used. In addition, the shape of the tab is not limited to rectangular shapes, and semicircular shapes like tab 71C may also be used, and trapezoidal shapes like tab 71F may be used. In addition, target connection portion 72 may be configured by providing a penetrating hole in said tab itself as in tabs 71D and 71E, but target connection portion 72 may also be configured by forming a notch as in tab 71B. In addition, positioning part 70 may be configured by notches 73A, 73B, 73C, or 73D formed in the corner or edge itself of nonwoven fabric 50, and positioning part 70 may be configured by penetrating hole 72. For example, a rectangular-shaped notch 73A or a semicircular-shaped notch 73B may be used. In addition, notch 73C cut out diagonally in the corner may be used, and notch 73D cut out in the shape of stairs in the corner may be used. Furthermore, notches 73A, 73B, 73C, and 73D and penetrating hole 74 can themselves function as target connection portions.

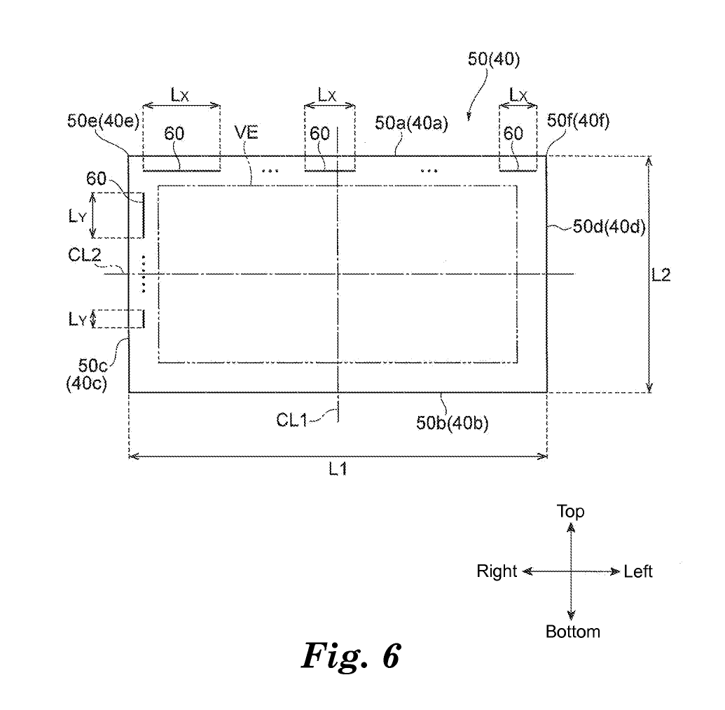

Here, fixing part 60 will be described with reference to FIG. 6 to FIG. 8. Fixing part 60 may take one form or a plurality of forms for nonwoven fabric 50. However, for one fixing part 60, a part of an area on the upper edge 50a side is fixed in a direction along at least upper edge 50a (the direction of the width here). Namely, for one fixing part 60, the whole area in the direction of the width of nonwoven fabric 50 is not fixed by extending it across the whole extent from side edge 50c to side edge 50d. For example, a fixing part formed along the whole area of upper edge 50a (a fixing part is extended along upper edge 50a from side edge 50c to side edge 50d) does not correspond to fixing part 60 in this embodiment. For example, as shown in FIG. 6, when fixing part 60 is formed with a size Lx that extends in the horizontal direction along upper edge 50a, size Lx is smaller than size L1 in the horizontal direction of nonwoven fabric 50. In addition, a plurality of fixing parts 60 may be formed along upper edge 50a, but each fixing part 60 is mutually separated in the direction of the width (or the up-down direction). When a plurality of fixing parts 60 are formed along upper edge 50a in this way, the total of the size Lx of each fixing part 60 is preferably smaller than the size L1 of the direction of the width of nonwoven fabric 50. In addition, the total of size Lx (if there is 1 fixing part 60, Lx is the size of the 1) is not particularly limited, but the total is 50% or less of size L1, preferably 10% or less. In addition, for one fixing part 60, a part of nonwoven fabric 50 may be fixed in a direction (the up-down direction in this case) along at least side edges 50c, 50d. One or a plurality of fixing parts 60 may be formed so that it extends in the up-down direction along side edge 50c (50d). In this case, the total of size Ly (if there is 1 fixing part 60, Ly is the size of the 1) is not particularly limited, but the total is 50% or less of size L2 of nonwoven fabric 50, preferably 10% or less. As long as the above relationships are satisfied, fixing part 60 may by formed in any shape at any position in any quantity. For example, a fixing part 60 as shown in FIG. 6 with a linear shape (a width that is negligibly small relative to the overall size of nonwoven fabric 50) having a fixed length relative to nonwoven fabric 50 may be used, but a fixing part 60 with a planar shape occupying a fixed area relative to nonwoven fabric 50 may also be used. For example, fixing part 60 may be formed in a rectangular shape, a polygonal shape, a circular shape, or the like so that it has a size Lx in the width direction and the size Ly in the up-down direction. In addition, a fixing part 60 having a sufficiently small point shape relative to nonwoven fabric 50 may be used. Or combinations thereof may be used. In addition, for example, a fixing part 60 may be further formed on the inner side or outer side of a fixing part 60 as shown in FIG. 6 and may have a plurality of stages.

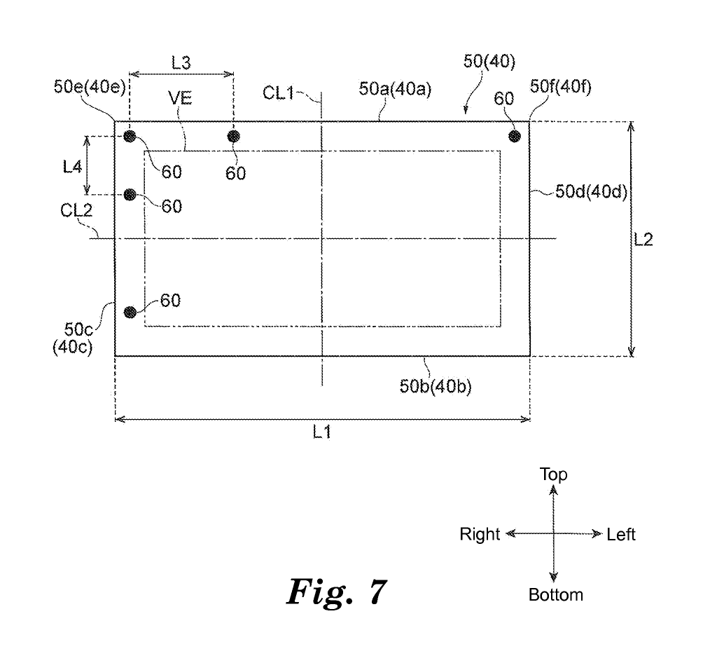

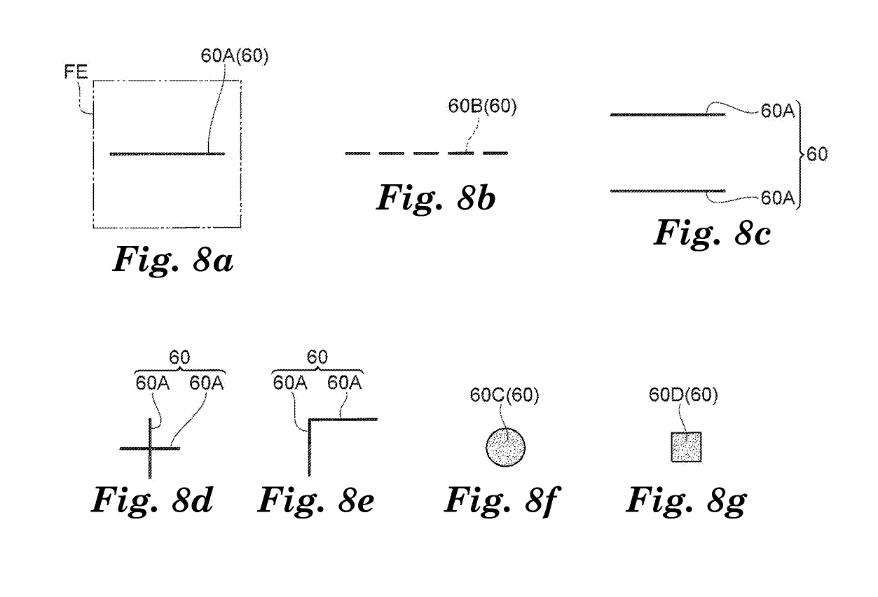

If nonwoven fabric 50 and optical sheet 51 are fixed by a small point-shaped fixing part 60, the generation of wrinkles or the like can effectively be suppressed. This type of “point-shaped fixing part” will be described in detail with reference to FIG. 7 and FIG. 8. A point-shaped fixing part 60 means that when nonwoven fabric 50 is viewed overall, fixing part 60 is a dot on nonwoven fabric 50. Namely, the size of 1 point-shaped fixing part 60 is so small that it can essentially be treated like a “point” compared to the size of nonwoven fabric 50 overall. It is not a planar-shaped fixing part 60 with a fixed area or a linear fixing part 60 with a fixed length as described above. In addition, sufficient clearance is ensured between 1 point-shaped fixing part 60 and other point-shaped fixing parts 60.

The size of each point-shaped fixing part 60 will be described with reference to an example in FIG. 8. A point-shaped fixing part 60 is so small as to have no affect on the generation of wrinkles when used for a surface illuminant device 10 (details to follow), and as long as it is small enough that it can essentially be treated like a “point” compared to the overall size of nonwoven fabric 50 as described above, its size and shape are not particularly limited. For example, as shown in FIG. 8, if the size of fixing part formation area FE is set extremely small relative to nonwoven fabric 50, any configuration may be used for fixing part 60 if the size and shape fit inside said fixing part formation area FE. Fixing part formation area FE is an area that is so small that it can essentially be treated as a “point” compared to the overall size of nonwoven fabric 50. For example, it may be a square (or a circle with a corresponding diameter) with one side being 2 mm or larger and 200 mm [or smaller], preferably 5 mm or larger and 100 mm or smaller. However, said dimensions may vary appropriately with the overall size of nonwoven fabric 50, and as surface illuminant device 10 gets larger, the size of fixing part formation area FE that can be treated as a “point” will also vary. Fixing part 60 may be any size or shape that fits into fixing part formation area FE, and it may be configured by a single fixing line 60A (nonwoven fabric 50 and optical sheet 51 are fixed only by the part shown as line 70A) as shown in FIG. 8(a). In addition, if a plurality of fixing parts are closely grouped within fixing part formation area FE, which is extremely small relative to nonwoven fabric 50, the group of the plurality of fixing parts within said fixing part formation area FE may be treated as “one fixing part 60”.

For example, as shown in FIG. 8(b), fixing part 60 may be configured from a fixing line 60B configured as 1 fixing line in the shape of a perforated line. In addition, as shown in FIG. 8(c), fixing part 60 may be formed from a plurality of fixing lines 60A (provided that all the fixing lines 60A fit inside fixing part formation area FE [sic]. In addition, fixing part 60 may be configured by forming a cross from fixing lines 60A as shown in FIG. 8(d), and it may be configured by putting fixing lines 60A in an L-shape as shown in FIG. 8(c). In addition, as shown in FIG. 8(f), fixing part 60 may be configured by a circular fixing area 60C (where nonwoven fabric 50 and optical sheet 51 are fixed by the part surrounded by fixing area 60C). In addition, as shown in FIG. 8(g), fixing part 60 may be configured by a rectangular fixing area 60D and may be configured by fixing areas involving other shapes.

The position and the like where fixing part 60 is formed in nonwoven fabric 50 (joined sheet 40) will be described below. Fixing part 60 is formed in at least the area of one edge side in one direction along the surface direction in nonwoven fabric 50. When a central line CL2 is set as the center position in the up-down direction of nonwoven fabric 50, the “area of one edge side” is the area on the upper edge 50a side or lower edge 50b side from said central line CL2. In addition, when a central line CL1 is set as the center position in the crosswise direction of nonwoven fabric 50, it is the area on the left edge 50c side or right edge 50d side from said central line CL1. Furthermore, when forming fixing part 60 on at least the upper edge 50a side or lower edge 50b side, at least a pair of fixing parts 60 may be formed on opposite sides of central line CL1. In this way, both nonwoven fabric 50 and optical sheet 51 are fixed so they are well-balanced.

In addition, fixing part 60 may be formed at a position along each edge 50a, 50b, 50c, and 50d. In addition, if an effective area VE, which is a range having an impact on the optical properties of surface illuminant device 10, is set, fixing part 60 may be formed outward from effective area VE. Furthermore, effective area VE is defined as an area that could have an impact on the optical properties of the light incident upon said effective area VE that is eventually emitted as the light from surface illuminant device 10. Meanwhile, the area outside effective area VE is defined as an area where light does not strike nonwoven fabric 50 (such as where the light from light source 11 is shielded by support member 52 or the like) or an area that does not have an impact on the optical properties of the light even when it strikes nonwoven fabric 50 and is diffused in said area. However, fixing part 60 may be formed on the inner side of effective area VE.

In addition, fixing part 60 may be formed in the corner between one edge of nonwoven fabric 50 and an edge adjacent to said edge. For example, fixing part 60 may be formed in each corner 50e and 50f between upper edge 50a and side edges 50c and 50d. Furthermore, in addition to the corners, fixing part 60 may be formed in sections other than the corners of edges 50a, 50b, 50c, and 50d. In addition, fixing part 60 may be formed only in sections other than the corners of edges 50a, 50b, 50c, and 50d and not in the corners. In addition, if positioning part 70 (see FIG. 4) is configured to be connectable support member 52, fixing part 60 may be formed in a position corresponding to said positioning part 70. Furthermore, “fixing part 60 is formed at a position corresponding to positioning part 70” includes not only when fixing part 60 is formed at positioning part 70 itself, but also when fixing part 60 is formed at a position along edges 50a, 50b, 50c, or 50d that is slightly separated towards the inner side from positioning part 70. For example, as shown in FIG. 11, fixing part 60 may be formed on tab 71 itself, on the inner side from tab 71, or at the boundary between edge 50a and tab 71.

As shown in FIG. 4 and FIG. 5, in the present embodiment, a pair of fixing parts 60 may be formed in the area of the upper edge 50a side on both the side edges 50c and 50d sides. In addition, fixing parts 60 are formed in the corners 50e and 50f. In addition, because positioning parts 70 are formed so that they are connectable to support member 52 in said corners 50e and 50f, fixing parts 60 are formed at positions corresponding to positioning parts 70. Specifically, fixing parts 60 are formed by linear fixing lines extending straight from a position near the upper end on side edges 50c and 50d (a position near the attachment point of tab 71) towards a position near the end in the crosswise direction on upper edge 50a (a position near the attachment point of tab 71). Fixing parts 60 are formed only at corners 50e and 50f and not in other areas. Namely, fixing part 60 is not formed in the area between corners 50e and 50f on upper edge 50a. However, one or more fixing parts 60 may be formed at any position in said area, e.g., fixing part 60 may be formed at the center position in the crosswise direction. In addition, fixing parts 60 are not formed in the areas below corners 50e and 50f in side edges 50c and 50d. However, one or more fixing parts 60 may be formed in any position in said area. In addition, fixing parts 60 are not formed in the areas on the lower edge 50b side in nonwoven fabric 50. However, one or more fixing parts 60 may be additionally formed in said area, e.g., fixing part 60 may be formed at any position along lower edge 50b (for example, the center position) and in the area of the lower edge 50b side on side edges 50c and 50d.

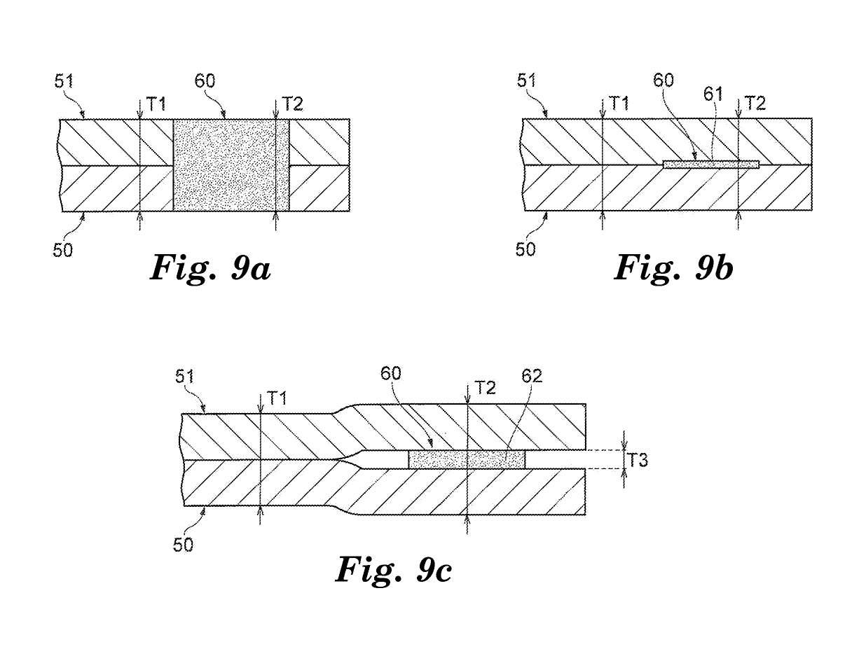

In addition, fixing part 60 may fix nonwoven fabric 50 and optical sheet 51 in a manner in which a gap is not formed between nonwoven fabric 50 and optical sheet 51. The phrase “fixed in a manner in which a gap is not formed” indicates that nonwoven fabric 50 and optical sheet 51 are fixed without a gap between them or that they are fixed such that it has no impact on the performance of surface illuminant device, even if a gap is formed, so that thickness T1, which is the thickness of nonwoven fabric 50 and optical sheet 51 on top of each other at a position other than at fixing part 60, and thickness T2, which is the thickness at fixing part 60, are approximately the same Specifically, as shown in FIG. 9(a), fixing part 60 may be formed by bringing together by melting the members actually being joined, as with hot-melt adhesive, ultrasonic welding, high-frequency welding, vibration welding, laser welding, and the like. Using said method, the thickness T2 can be set to be approximately the same as thickness T2 without forming a gap because a separate member is not interposed between optical sheet 51 and nonwoven fabric 50. Alternatively, as shown in FIG. 9(b), even if fixing part 60 is formed by interposing between nonwoven fabric 50 and optical sheet 51 a separate member (adhesive or glue) for joining them, by choosing something that is extremely thin (e.g., a thickness of 40 μm or less) for said joining member 61, optical sheet 51 and nonwoven fabric 50 may be formed essentially without a gap between them. In this way, fixing nonwoven fabric 50 and optical sheet 51 in a manner in which a gap is not formed between nonwoven fabric 50 and optical sheet 51 accomplishes the following advantages. Namely, when the thickness at fixing part 60 is larger, it is possible for fixing part 60 to get wedged between support member 52 or the like and other members. Under these circumstances, if there is deformation in the surface of joined sheet 50 due to heat or the like, it is possible that wrinkles or the like will occur. However, if the thickness T2 of fixing part 60 is approximately the same as thickness T1, the generation of wrinkles resulting from this effect can be suppressed. Furthermore, as shown in FIG. 9(c), a joining member 62 that is thicker than joining member 61 may be used. In this case, a gap is formed between nonwoven fabric 50 and optical sheet 51 due to the effect of the thickness T3 of joining member 62, and the thickness T2 at fixing part 60 will be bigger than thickness T1.

The surface illuminant device 10 as described above will be manufactured by the following manufacturing method. First, joined sheet 40 is formed by joining nonwoven fabric 50 and optical sheet 51. At this point, nonwoven fabric 50 and optical sheet 51 are aligned in the surface direction using positioning part 70. Next, nonwoven fabric 50 and optical sheet 51 are fixed with fixing part 60 at least in the area of the upper edge 50a side. At this point, one fixing part 60 is formed so that it is fixed in a part of an area on said upper edge 50a side in a direction along at least upper edge 50a (the direction of the width here). Next, joined sheet 40 is supported by support member 52 by connecting target connection portion 72 of positioning part 70 with connection portion 53 of support member 52. Combining this with the light source 11 and the like completes surface illuminant device 10.

Next, the effects and advantages of surface illuminant device 10 according to the present embodiment will be described.

First, because acrylics, polycarbonates, polystyrenes, styrene-methyl methacrylates, cycloolefins, and the like are used as the material of the diffusion member in conventional surface illuminant devices, this sufficiently increases the strength of the diffusion member itself. There have been cases in which nonwoven fabrics have been used as the diffusion member in these types of surface illuminant devices. However, because the strength of the member itself is weaker than conventional diffusion members, there have been cases in which the support is not sufficient for incorporation in a product, and some kind of support mechanism was necessary. However, there are cases in which it is not appropriate to use a large-scale mechanism just to support a nonwoven fabric, such due to production cost and product size considerations. Meanwhile, when supporting nonwoven fabric with a simple configuration, there are sometimes optical disadvantages, such as wrinkles forming in the nonwoven fabric.

Meanwhile, according to the surface illuminant device and manufacturing method according to the present embodiment, by fixing both nonwoven fabric 50 and optical sheet 51 with fixing part 60, they can be treated as one joined sheet 40 in which nonwoven fabric 50 and optical sheet 51 are combined with each other. Therefore, even when using a low-strength nonwoven fabric 50 as diffusion member 14, because it is possible to configure it as one joined sheet that is strong because it is joined to another optical sheet 51 (at least stronger than a configuration with a single nonwoven fabric 50), the strength of the member can be ensured, even with a simple configuration. If nonwoven fabric 50 and optical sheet 51 are fixed over a wide range, it is possible for wrinkles to form in nonwoven fabric 50. For liquid crystal displays, for example, because the temperature rises and falls repeatedly during repeated use, it is possible for wrinkles to form in nonwoven fabric 50 at the boundaries between where it is fixed and not fixed when it is fixed over a wide range because of the difference in the coefficient of thermal expansion between optical sheet 51 and nonwoven fabric 50. For example, if a linear fixing part is formed such that it extends across the whole area in the crosswise direction on upper edge 50a of nonwoven fabric 50, wrinkles may form in nonwoven fabric 50, and this would affect the optical properties of surface illuminant device 10. Meanwhile, in the present embodiment, nonwoven fabric 50 and optical sheet 51 are fixed by fixing part 60 at least in the area of the upper edge 50a side. In addition, for one fixing part 60, a part of the area on the upper edge 50a side (a part near upper edge 50a in this case) is fixed in the direction along at least upper edge 50a. Because of this type of fixing part 60, the generation of wrinkles or the like in nonwoven fabric 50 can be suppressed even when it is affected by heat or the like. If a fixing part 60 like the one described above is used, unlike when the whole area of upper edge 50a is fixed, because nonwoven fabric 50 and optical sheet 51 are partially fixed, there is concern about the strength of the points of fixation. However, because nonwoven fabric 50 has low mass compared to conventional diffusion members, even when fixing part 60 is only partially fixed, it can ensure a fixing strength that is sufficient for impacts estimated for the impact-resistance performance required for surface illuminant device 10 (this point can also be checked by the drop testing in the embodiment example described below). In addition, because nonwoven fabric 50 is a member that easily releases heat and humidity compared to conventional diffusion members, it is strong in conditions such a certain amount of heat and humidity over a long time period and conditions in which there is a high-temperature and low-temperature cycle (this point can also be checked by the temperature testing in the embodiment example described below). Accordingly, sufficient optical properties can be ensured with a simple configuration, even when using nonwoven fabric 50 as a diffusion member.

In addition, in surface illuminant device 10 according to the present embodiment, nonwoven fabric 50 is formed in a rectangular shape, and fixing parts 60 are formed in the corners 50e and 50f between upper edge 50a and side edges 50c and 50d adjacent to said upper edge 50a. In this way, by fixation in corners 50e and 50f in the rectangular nonwoven fabric 50, the nonwoven fabric can be supported in a well-balanced way, and the formation of wrinkles can also be suppressed. In particular, when surface illuminant device 10 is used in liquid crystal displays, because it is fixed in corners 50e and 50f on the upper edge 50a side against the effects of gravity, it can be supported in a more well-balanced way.

Furthermore, in the present embodiment, because positioning parts 70 are formed in corners 50e and 50f, the result is that fixing parts 60 are formed in positions corresponding to positioning parts 70, and they are also formed in corners 50e and 50f. However, when positioning parts 70 are disposed in places other than corners 50e and 50f and fixing parts 60 are formed in corners 50e and 50f, the aforementioned advantages can be achieved independently.

In addition, surface illuminant device 10 according to the present embodiment is further provided with support member 52 for supporting nonwoven fabric 50 and optical sheet 51. In addition, nonwoven fabric 50 and optical sheet 51 are provided with positioning part 70 for adjusting their mutual positions in the surface direction, and positioning part 70 is configured to be connectable to support member 52. In addition, fixing parts 60 are formed at positions corresponding to positioning parts 70. For example, if the distance between the places where positioning parts 70 and support members 52 are connected is great, if joined sheet 40 is deformed in the surface direction due to heat or the like (in other words if nonwoven fabric 50 is light), a moment could be generated. Consequently, by forming fixing parts 60 at positions corresponding to positioning parts 70, namely, at positions near positioning parts 70, said moment can be suppressed. Furthermore, in the present embodiment, because positioning parts 70 are formed in corners 50e and 50f, the result is that fixing parts 60 are formed in positions corresponding to positioning parts 70, and they are also formed in corners 50e and 50f. However, when positioning parts 70 are disposed in places other than corners 50e and 50f and fixing parts 60 are formed in positions corresponding to positioning parts 70, the aforementioned advantages can be achieved independently.

The present invention is not limited to the above embodiments.

For example, in the above embodiments, the use of a surface illuminant device in liquid crystal display modules was described as an example, but the present invention is not limited to these types of displays devices, and surface illuminant devices may be used in billboards, ceiling lights, indoor lighting equipment, outdoor lighting equipment, vehicle lighting equipment, and the like. Furthermore, in the above embodiments, the front surface and back surface extended in the up-down direction by standing the whole surface illuminant device up vertically, but it could be used by extending the front surface and back surface horizontally as in a ceiling light source.

In addition, in the above embodiments, the surface illuminant device and nonwoven fabric were formed into a rectangular shape, but the shape is not particularly limited, and other shapes could be used, for example.

In addition, in the above embodiments, both the nonwoven fabric and optical sheet were configured to be exactly the same shape and size, but to the extent that it does not affect the optical properties, they may alternatively not have the same shape. For example, the nonwoven fabric may be configured to protrude over the edges of the optical sheet, and the optical sheet may be configured to protrude over the edges of the nonwoven fabric.

### EXAMPLES

The surface illuminant device according to one form of the present invention based on an embodiment example will be described below in detail, but the configuration of the surface illuminant device is not limited to the following embodiment example.

### Embodiment Example

A joined sheet was formed by joining a nonwoven fabric and a prism sheet. It comprised a positioning part as shown in FIG. 4 and FIG. 5, and the nonwoven fabric and prism sheet were fixed by forming a pair of fixing parts at the positions shown in said FIG. 4 and FIG. 5. At this point, it was welded by heating it at 300° C. for 6-10 seconds using a PC-300 made by Fuji Impulse. Furthermore, a nonwoven fabric with a grammage of 70 g/m² made by 3M was used for the nonwoven fabric, and a prism sheet taken out of a 32S5 LCD television made by Toshiba was used for the prism sheet. Furthermore, the joined sheet had a height of 404.3 mm in the up-down direction and a width of 707.9 mm in the crosswise direction. This joined sheet was inserted into the same 32S5 LCD television made by Toshiba.

### Comparative Example

A nonwoven fabric and prism sheet were fixed by welding the whole area in the crosswise direction of the upper edge of the joined sheet. The other conditions were the same as for the embodiment example.

### Appearance Evaluation

In the LCD television according to the comparative example, screen distortions due to the generation of wrinkles in the nonwoven fabric of the joined sheet were observed. Meanwhile, in the LCD television according to the embodiment example, a favorable appearance was obtained due to the fact that wrinkles and flexure did not occur in the joined sheet.

### Drop Testing

Next, the LCD television according to the embodiment example was packaged like it was when it was being distributed, and drop testing was performed. For the drop testing, 4 tests were performed 3 times each: a test in which the upper edge side was dropped to the ground, a test in which the bottom side was dropped to the ground, a test in which the front side was dropped to the ground, and a test in which the back side was dropped to the ground, all from a height of 900 mm. After that, the appearance was observed, and no wrinkles, flexure, slipping, or the like occurred, and no screen distortions were observed.

### Temperature Testing

Temperature testing was performed on the LCD television according to the embodiment example. First, it was left under the conditions of a temperature of 40° C. and a humidity of 90% RH for 1000 hours. Next, it was left under the conditions of a temperature of 40° C. and a humidity of 0% for 1000 hours. In addition, a cycle of −20° C. for 1 hour and 60° C. for 1 hour was repeated 214 times. Its appearance was observed in said temperature testing, but no wrinkles, flexure, slipping, or the like occurred in the nonwoven fabric under any testing conditions, and no screen distortions were observed.

### DESCRIPTION OF REFERENCE NUMERALS

10: surface illuminant device, 14: diffusion member, 40: joined sheet, 50: nonwoven fabric, 51: optical sheet, 52: support member, 60: fixing part, 70: positioning part

1. A surface illuminant device comprising:
a light source for emitting light;
a nonwoven fabric configured as a diffusion member for diffusing the light; and
an optical sheet positioned on at least one of a rear surface side and a front surface side of the nonwoven fabric,
wherein the nonwoven fabric and the optical sheet are fixed by one or more fixing portions at least at one edge side region of the nonwoven fabric in a first direction along a surface direction, and
one fixing portion fixes a part of the region at least in the direction along said one edge.

2. The surface illuminant device according to claim 1, wherein
the nonwoven fabric is formed in rectangular shape, and
the fixing portion is formed at a corner of said one edge and an adjacent edge thereof.

3. The surface illuminant device according to claim 1, further comprising a support member for supporting the nonwoven fabric and the optical sheet,
wherein the nonwoven fabric and the optical sheet are provided with a position aligning member for aligning positions in the respective surface directions thereof,
the position aligning member is formed connectably with the supporting member, and
the fixing portion is formed at a position corresponding to the position aligning member.

4. The surface illuminant device according to claim 1, wherein the fixing portion fixes the nonwoven fabric and the optical sheet so as to form no gap between the nonwoven fabric and the optical sheet.
